(19) United States
(12) Patent Application Publication
(10) Pub. No.: US 2006/0134311 A1
(43) Pub. Date: Jun. 22, 2006

(54) Starch-based rubber-elastic confectionery

(76) Inventors: Rolf Mueller, Zurich (CH); Federico Innerebner, Zurich (CH)

Correspondence Address: Jordan & Hamburg, 122 East 42nd Street, New York, NY, 10168, US

(21) Appl. No.: 10/539,150

(22) PCT Filed: Dec. 19, 2003
(86) PCT No.: PCT/CH03/00832

§ 371 Date: Jan. 26, 2006

(30) Foreign Application Priority Data
Dec. 20, 2002 (DE) 102609632

(51) Int. Cl. A23G 3/00

(52) U.S. Cl. 426/660

(57) ABSTRACT

Disclosed is a rubber-elastic confectionery based on a starch matrix, the rubber-elastic texture being due to a network of the starch matrix. The starch matrix can be adjusted for a wide range of textures that are commonly used in confectioneries and can especially be used to replace gelatin or in gummy-type sweets such as gummy bears or in jelly products. In addition, entirely new texture properties can be obtained.

### BACKGROUND OF THE INVENTION

The invention relates to novel, rubber-elastic candy based on a starch matrix, the rubber-elastic texture being based on a network of the starch matrix.

Conventional candy, based on starch, can be divided into two groups:

1. Candy, based on starch, the starches used, such as starches with a high amylose content, having a pronounced tendency to form a gel at the concentration used. Such starch gels have a tightly meshed, interlinked network, the network elements being formed by homocrystallites. High gel strengths and high dimensional stabilities result. However, such gels, as do practically all previous starch gels, have a pronounced brittleness and only a slight elongation at break of typically less than 50%, especially in comparison with candy based on gelatin.

2. Candy based on starch, the starches used not having any gel-forming tendency worth mentioning at the concentrations used. These are highly viscous liquids, which permit high elongations of more than 100% only within a narrow range of water contents. The starches exist almost completely in an amorphous state. This group of candies includes, in particular, former gummy bears based on starch. At higher water contents (that is, at higher relative humidities), as well as at an elevated temperature (summer), such candy becomes very soft and tends to deliquesce. At low water contents (that is, at low relative humidities) as well as at lower temperatures (winter) such candy becomes comparatively hard. The texture properties differ qualitatively and quantitatively clearly from gelatin gummy bears. In particular, it has previously not been possible to attain the typical rubber-elastic property of gelatin with starch substitutes. In addition, the stickiness of this product (it sticks to the teeth), is particularly annoying.

For lack of a suitable alternative, jelly sugar goods and gummy candies, such as the known gummy bears, are produced predominantly at the present time on the basis of gelatins. It is, however, desirable to replace gelatin in foods, since gelatin has increasingly fallen into disrepute as an animal product and because of the BSE problem. In accordance with the general trend in the direction away from animal products, gelatin-free candy is increasingly demanded by the consumer and is also desirable for Moslems and Jews, since this group of consumers is not allowed to eat candy, which is generally based on pig gelatin.

A further alternative to gelatin gummy candies is based on pectin. However, on the one hand, pectin is comparatively expensive and, on the other, pectin gummy candies also do not have the desired consistency and have an undesirable inherent taste.

Gelatin, as well as agar and pectin are also used in the area of jelly sugar goods. In comparison to starch, agar and pectin are several times as expensive, so that jelly sugar goods based on starch represent a promising solution, provided that the product has the desired, elastic consistency.

### SUMMARY OF THE INVENTION

It was found that candy, based on a starch matrix with rubber-elastic properties and high to very high elongations at break, especially with textures very comparable to the textures of products based on gelatin, can be obtained. The solution lies between the two main groups of candy based on starch, which are described above in the state of the art. It consists of a starch matrix, which, on the one hand, has a high amorphous portion and, on the other, a defined starch network with a low network density. Descriptively, the inventive starch matrix with the amorphous portion has a structure component, which, as is the case with former gummy bears on a starch basis, exhibits a viscous behavior. However, this structure can be intensified and rubber-elastic property characteristics can be introduced by adjusting the network to be defined and minimal. In comparison to previous jelled candy based on starch, the network has a clearly reduced network density. On the one hand, the linkage points of the network are sufficient for preventing viscous flow of the amorphous portion of the structure and, on the other, the network density is slight or the connecting elements between the linkage points are long enough, so that the structure can be subjected to high deformations without tearing the network. Moreover, in the unstressed state of the matrix, the connecting elements are in a state of high entropy or in a tangled state and can be stretched when stressed. The restoring force, comparable with that of gum, has its basis in the entropy elasticity.

In the stricter sense, the invention is therefore related to the production of such defined networks with rubber elastic property features. Compared to proteins, which, in the case of gelatin, form a network, starch macromolecules are comparatively rigid and inelastic, as a result of which the adjustment to a rubber elastic behavior is made more difficult. However, this problem can be eased by using large starch macromolecules and/or by modifying and, especially, substituting the macromolecules. By elongating hydroxyl groups of the anhydroglucose units of starch macromolecules, for example, by hydroxypropylation, additional degrees of freedom of the macromolecules arise, as a result of which the mobility increases.

It was found that the advantages of candy, based on conventional starch gels and the advantages of candy based on viscous or amorphous starch can be maintained without the respective disadvantages if the starch matrix:

A

1. has at least one high molecular weight starch with a lesser to disappearing retrogradation tendency (existing starch, VS),
2. optionally has at least one additional starch, capable of forming a network (NS),
3. and has a minimal network, the network elements of which are formed by homocrystallization of the VS and/or by heterocrystallization of the VS with the NS,
   or the starch matrix:
   B
1. has at least one VS of reduced molecular weight with a lesser to a disappearing retrogradation tendency,
2. and, additionally, at least one NS,
3. and has a minimal network, the network elements of which are formed by homocrystallization of the VS and, preferably or, by heterocrystallization of the VS with the NS.

### BRIEF DESCRIPTION OF THE DRAWINGS:

FIG. 1 shows stress-strain curves obtained in tensile test from samples which were in equilibrium with air having a relative humidity of 43%.

FIG. 2 shows stress-strain curves of the same samples which are an equilibrium with a relative humidity of 58%.

FIG. 3 shows that the strength and elongation at break of GGB are reduced if the relative humidity is increased further to 75%.

FIG. 4 shows the course of the elongations at break of GGB, GSB and SB which are given as a function of the relative humidity at equilibrium.

FIG. 5 shows the course of the modulus of elasticity of GGB, GSB and SB shown in semilagarithmic form as a function of the relative humidity.

FIGS. 6 and 7 show formulations GB16 and GB19 (neither of which contains NS) wherein the networks, linkage points of which are formed by homocrystallities.

FIG. 8 shows the result for gelatin as well as for hard rubber-elastic formation GB17 and for a soft rubber-elastic texture GB32.

FIG. 9 shows the effect of plastersizer and NS on the modulus of elasticity in semilogorithmic form for formulations based on acetylated distarch adipate of waxy corn.

FIG. 10 shows that increasing the NS content is expressed in a shift the modulus of elasticity plateau to a higher modulus of elasticity.

FIG. 11 shows the elongations at break of various formulations as a function of the relative humidity.

### DESCRIPTION OF THE PREFERRED EMBODIMENTS

By using a high molecular weight starch with a lesser to disappearing retrogradation tendency in accordance with A, the starch being, for example, a waxy or modified starch, on the one hand, a low to disappearing network density is obtained, as result of which crystalline or partially crystalline fixing points are introduced at low network densities, so that a viscous flow is prevented and, on the other, an entropy elastic behavior becomes possible, resulting in a high extensibility. The combination of the VS with an NS is advantageous when a VS with a low tendency to undergo retrogradation is used and necessary when a VS with a disappearing tendency to undergo retrogradation is used. In this connection, the NS has a low molecular weight and good crystallization properties and can form mixed crystallites (hetero crystals) with the VS, the linkages between the crystallites being formed by the VS. The use of the NS has the important advantage that, on the one hand, the resulting network density can be adjusted precisely by the proportion of NS used and, on the other, as a result of the low molecular weight of the NS and the therewith associated crystallization rate, which is clearly higher than that of high molecular weight starches, this network can be formed very quickly, which is advantageous for manufacturing processes. A further advantage of the low molecular weight NS consists therein that its molecular weight can affect the size of the hetrocrystallites and, in particular, can minimize it. On one hand, this is of importance for the transparency, since crystallites with dimensions of at least the order of magnitude of the wavelength of visible light lead to intransparency or opacity. On the other hand, smaller crystallites, which lead to finely structured networks, are also advantageous for rubber elastic behavior (reduced stress relaxation). Moreover, the use of NS is associated basically with an increased scope of possibilities with regard to the range of the adjustable structures and, associated therewith, the range of adjustable property profiles, as well as with regard to the manufacturing processes.

If, in accordance with B, at least one VS with a reduced molecular weight and with a lesser to disappearing tendency to undergo retrogradation is used, the additional use of an NS for the development of the rubber elastic networks is not optional but essential. The advantages, which have been named when NS is used, apply also here. However, the networks, obtained according to B, have reduced elongations at break in comparison to the networks obtained according to A. The elongations at break decrease with the molecular weight of the VS. However, this can be counteracted by high degrees of modification of the VS. On the other hand, advantages arise due to the also reduced viscosity of the candy composition during the processing, for example, during the casting procedure. However, a reduced elongation at break need not be disadvantageous. In comparison to gummy candy, jelly candy, for example, has a clearly shorter texture, which, accordingly, could also be adjusted in accordance with B.

Solutions between A and B are also advantageous, depending on the requirements of the texture aimed for and the manufacturing processes selected. For example, a VS of A can be mixed with a VS of B in any ratio, so that the range of the resulting textures and of the viscosity of the candy composition during the processing is wide.

The proportion AN of the mechanical properties, such as the modulus of elasticity, which can be attributed to the network and its mechanical properties, depends only slightly on the water content, that is, a plateau results in the function of the relative humidity. On the other hand, the proportion A_{A}, which is attributed to the amorphous starch phase, exhibits a pronounced dependence on the water content. At temperatures below the glass transition temperature Tg, the A_{A} portion dominates the mechanical properties and, at temperatures above the glass transition temperature Tg, the A_{N} portion dominates, a quasi plateau resulting. The position of the quasi plateau along the relative humidity axis can therefore be adjusted by the parameters, which affect the Tg, especially by plasticizers such as polyols, for example, glycerin, sorbitol and maltitol. Sugars and sugar types are also effective in this regard, but not as pronouncedly as polyols, At low polyol contents, the quasi plateau lies at high relative humidities and, at high polyol contents, it can be extended to low relative humidities.

The level of the quasi plateau is determined, on the one hand also by the plasticizer content, an increase in the plasticizer content lowering the level. On the other, the level is determined by the network density, an increase in the network density raising the level. In addition, the level is also determined by the VS selected (origin, molecular weight, amylose content, modification, degree of modification).

The present invention makes possible a wide range of starch matrixes with a rubber elastic behavior, which are obtained with a short to long texture and can be used variously for different candy articles. The starch matrixes may be laden with materials such as sugars, sugar types, polyols, aromas, additives, etc., which are typical for the particular candy, and have the following advantageous characteristics:
1. A rubber elastic behavior. The degree of rubber elasticity can be adjusted in a defined manner by various parameters of the formulation and of the method, especially by the nature and the amount of the NS. In particular, the rubber elasticity, which is typical for gelatins, may also be obtained.
2. A plateau in the modulus of elasticity as a function of the relative humidity. The level of the quasi plateau can be adjusted along the modulus of elasticity axis, that is, vertically and the position of the quasi plateau can be adjusted along the relative humidity axis, that is horizontally. As a result of the plateau, the texture properties are stabilized in the direction of high relative humidities, that is, the fluctuations in product properties with changes in temperature and relative humidity are reduced.
3. The elongations at break, which almost correspond to the elongations at break of candy based on gelatin and, in addition, can be adapted to the requirements of specific candy products (short to long texture).
4. The transparency can be adjusted to be opaque, semi-transparent as well as transparent.
5. The fracture properties can be adjusted from ductile to brittle (glassy).
6. The surface properties can be adjusted from tacky to not tacky without using auxiliary materials.
7. Production is possible with methods customary in the candy area, for example, by means of casting techniques (mogul technique) or molded extrusion. In addition, production by injection molding techniques is also possible.

It is pointed out that the inventive starch matrix cam be combined with further materials, which are used as structure-giving components for candy, for example, with proteins and pectins or polysaccharides, such as agar, gum Arabic, carrageenan, carob flour, xanthan and the like. In addition, because of the starch crystallites contained therein, a portion of the inventive candy has prebiotic activity.

Starches Present (VS)

The starches present may originate from anywhere, provided that they have a low retrogradation tendency. They may be native, as well as modified.

In order to obtain inventive starch matrices with a sufficient entropy elasticity, VS with degrees of polymerization DPn of more than 150, preferably of more than 300, especially of more than 500, particularly of more than 750 and more particularly of more than 1000 are used.

Of the native starches, those with an amylose content of less than 20%, preferably of less than 15%, particularly of less than 10% and especially of less than 5%, preferably waxy starches, such as waxy rice starch, waxy corn starch, waxy panic grass starch or waxy potato starch, are used as VS starches.

Further modified starches, particularly starches, which have been substituted to stabilize them against retrogradation, such as, for example acetylated, hydroxypropylated, hydroxyethylated, phosphorylated, oxidized and oxidized and acetylated starches or the corresponding starches, which have additionally been cross linked chemically (distarch phosphate, distarch adipate), are suitable for use as VS. In general, the suitability of these starches increases with the degree of modification.

In waxy or hetero waxy starches with high degrees of substitution, the retrogradation tendency is reduced so far, that networks, which could induce rubber elastic behavior and a modulus of elasticity plateau, can no longer be formed at the concentrations used. On the other hand, such starches, particularly starches with a high degree of substitution, have a particularly pronounced and advantageous elongation capability. However, by combining such VS with suitable NS, advantageous networks may be obtained also on the basis of these starches, these networks coming about at least partly due to heterocrystallization of VS with NS.

Starches, Capable of Forming a Network (NS)

Since it is not possible to produce rubber elastic behavior and to stabilize this behavior over a wide range of the relative humidity on the basis of an amorphous phase alone, a defined network is introduced, as a result of which the structure is strengthened and rubber elastic behavior becomes possible. Preferably, networks are produced, which are coupled with the amorphous phase. This coupling can be achieved by selecting a suitable NS and by matching the NS to the VS under suitable process conditions.

Starches, which contain or consist of amyloses, are used as NS. The amyloses may be linear or also branched and optionally are modified. Examples of NS are amyloses from native starches, especially amyloses, with an amylose content of more than 23% obtained by fractionating starches, modified amyloses, particularly substituted amyloses or hydrolyzed amyloses, synthetic amyloses, grain starches, pea starches, starches with a high amylose content, especially with an amylose content of more than 30%, preferably of more than 40%, particularly of more than 60% and most particularly of more than 90%, hydrolyzed starches, particularly hydrolyzed starches with a high amylose content, gelling dextrins, fluidity starches, microcrystalline starches and starches from the area of fat replacers. In addition, NS may also have an intermediate fraction, for example, as contained in starches with a high amylose content and obtained by fractionation. With respect to structure and properties, the intermediate fraction is between amylose and amylopectin.

The degree of polymerization of the NS preferably is less than 300, more preferably less than 150, particularly less than 100, especially less than 75 and most especially less than 50.

Customarily, amyloses are divided into long chain amyloses (LCA) with a DPn of more than 100, and short chain amyloses (SCA), with a DPn of less than 100.

Short Chain Amylose (SCA)

Examples of SCA are amylodextrins, linear dextrins, Nägeli dextrins, Lintnerized starches, erythrodextrins or achrodextrins, which represent different brands and subgroups of SCA.

SCA may be obtained, for example, by hydrolysis of LCA, of mixtures of LCA and amylopectin or of amylopectin mixtures. SCA, which is particularly suitable for advantageous networks, is obtained, for example, by the hydrolysis of starches originating from roots and tubers or bulbs or from a hetero waxy or waxy starches. The hydrolysis may be a chemical hydrolysis, such as an acid hydrolysis, and/or an enzymatic hydrolysis, such as a hydrolysis by means of amylases or a combination of amylases (alpha amylase, beta amylase, amyloglucosidase, isoamulate or pollulanase). Amylase-containing starches are obtained as SCA by a combined acid and enzyme hydrolysis. The two types of hydrolysis can be carried out simultaneously or consecutively. Depending on this, different types of SCA may be obtained starting out from the same starch. Moreover, the characteristics of SCA are also affected by the state of the native starch during the hydrolysis, for example, by the degree of swelling of the starch grains. A wide range of suitable SCA is therefore available. Further types may be obtained by acid/enzyme hydrolysis or enzyme hydrolysis starting out from waxy starches, SCA hydrolysates with a DPn typically of 22 being obtained, which are particularly suitable for the present invention.

Long Chain Amylose (LCA)

The amylose, contained in native starch, usually is LCA with a DPn of more than 100. The degree of polymerization DPn of LCA can, however, be reduced, for example, by acid hydrolysis and/or enzymatic hydrolysis and/or oxidation to values below 100, so that appropriately modified, native starches may also contain SCA.

Numerous methods for producing SCA, LCA and mixtures of SCA and LCA are known in the art. Both types of amylose can be obtained in pure form. They are also contained in different proportions in various, optionally hydrolyzed commercial starches.

Advantageous Networks

The structural prerequisites for coupling networks with the amorphous or predominately amorphous phase of VS are given by the chain length CLw (A-AP) of the A side chains of the amylopectin fraction and by the chain length of the amylose fraction. The chain lengths CLw (A-AP) of A side chains of amylopectin are approximately 10 to 20 for amylopectins from starches with an amylose content of less than 30, whereas starches with a high amylose content have somewhat longer chain lengths CLw. On the other hand, amyloses may also have very much longer chain lengths CL (LCA), which typically range from 100 to 1000, root and bulb or tuber starches having chain lengths, which are clearly higher than those of grain starches. For short chain amyloses (SCA), the chain lengths CL (SCA) are shorter than 100 and usually of about the same magnitude as the degrees of polymerization DP (SCA), CL (SCA) being less than the DP (SCA). Since information concerning the average weight CLw is available only in rare cases for the different starches, the number average CLn of the chain length distribution and the number average DPn of the distribution of the degree polymerization is used for a simplified discussion. Generally, the CLw is somewhat larger than the CLn, the difference in the case of A side chains of amylopectin being only a slight, since these have a narrow distribution, whereas the difference in the case of SCA is larger and, in the case of LCA, can even be very large.

The minimal chain length of amylose CLn (AM) and the minimum degree of the polymerization of amylose DPn (AM) in order to obtain coupling of a network with the amorphous phase by means of amylose, is at about CLn (AM) ˜CLn (A-AP), that is, at about 10 to 20, advantageous couplings being possible up to about CLn (AM)˜100. Networks, which are not coupled with the amorphous phase, that is, which consist predominantly of amylose, may also be formed above this value. These networks have disadvantageous properties with regard to the requirements set, for example, an opacity at higher relative humidities and clearly reduced elongations at break and ductilities compared to coupled networks.

For this reason, SCA is particularly suitable as an NS or as a portion of an NS for the preparation of networks coupled with the amorphous phase, the stability of the crystallites, forming the network points, that is, their size, decreasing as the CLn (AM) or the DPn (AM) decreases, and the transparency increasing.

Furthermore, when LCA are used, it is also possible to couple the network advantageously with the amorphous phase when the network-active chain length CLn,na (LCA) is in the range of the SCA chain length, that is, less than 100.

Irregularities can be introduced into the chain length CLn (AM) by chemical reactions, especially by substituting hydroxyl groups of the anhydroglucose monomer unit, by oxidation or by cross-linking. In the case of a chemical reaction in the center of mass of a segment, characterized by its chain length CL, the network-active chain length of CL is halved to ½CL. It is therefore possible to obtain advantageous networks, for example, by hydroxypropylation or acetylation on the basis of LCA. Advantageous degrees of substitution (DS) range from about 0.01 to 0.50.

Finally, advantageous networks based on LCA with a Cln,na>100 can be obtained if suitable conditions are created for this by process measures such as shaping at comparatively low water contents, low temperatures and/or heat treatment at a relative humidity ranging from 20 to 60% and/or the addition of RHS, the (extensive) association of the amylose with the amylose networks being suppressed and the (narrow) association of the amylose with the A side chains of amylopectin being favored.

NS is used in amounts of 1 to 40%, preferably of 1.5 to 30%, especially of 2 to 20% and particularly of 3 to 15%, based on VS+NS.

Activation and Stabilization of the Amylose

For making adjustments to obtain a defined network, NS and, optionally, VS is activated and especially stabilized before or during the mixing. As a result of the activation, the amylose, containing the NS, is present at least partly in an amorphous state, so that, after the mixing with VS, recombination can take place, which leads to a network. Due to the stabilization, it becomes possible to affect the start of the network formation and the nature of the network.

The patent applications WO 03/035026 A2 and WO 03/035044 A2 are referred to for detailed information concerning activation, stabilization, nucleation, under-cooling and exogenous nucleating agents.

Retrogradation-Inhibiting Materials

Retrogradation-inhibiting materials can be used advantageously for rubber-elastic candy based on VS alone or a combination of VS and NS. They make it possible to have an effect on the retrogradation behavior of the VS, which is of great importance for present invention. The retrogradation-inhibiting effect of these materials is based, on the one hand, on reducing the amount of water, available for the starch as plasticizer and, on the other, on the dilution of the starch phase. In both cases, the diffusion of the starch macromolecules is made more difficult and the incompatibility of retrogradation-inhibiting materials and starch existing with respect to a crystallization. Examples of suitable retrogradation-inhibiting materials are sugar types (such as sucrose, saccharose, fructose, glucose, maltose, glucose syrups, maltose syrups, fructose-containing starch hydrolysates), oligosaccharides, mixtures of oligosaccharides, especially those with a DE greater than 20, preferably greater than 25, especially greater than 30 and particularly greater than 70, polydextrose, mallodextrins, dextrins, pyrodextrins, especially with degrees of branching Qb greater than 0.05, preferably greater than 0.10, especially greater than 0.15 and particularly greater than 0.3, glycogen, lactose, etc.

Plasticizers

A wide range of known starch plasticizers (WM) is available, such as glycerin, sorbitol, maltitol, mannitol or xylitol (compare, for example, WO 03/035026 A2 or WO 03/035044 A2). They can be used alone or in various mixtures, glycerin being particularly preferred.

Sugars, Sugar Types, Additives, Aromas, Dyes, Coating Agents, etc.

The present invention makes a spectrum of starch matrices available, which can be used for different candy articles. These starch matrices may be filled with the same sugars, sugar types, aromas, dyes, additives, etc., that are customary for the respective candy.

The sugars and sugar types include, for example, sucrose, fructose, dextrose, maltose, trehalose, lactose, lactulose, trisaccharides such as raffinose, polyols such as glycerin, erythritol, xylitol, sorbitol, mannitol, galacticol, tagatose, lactitol, maltitol, maltulose, isomalt, hydrogenated starch hydrolysates, as well as syrups such as glucose syrup, high maltose corn syrup and high fructose corn syrup. Furthermore, so-called low-calorie sweeteners, such as saccharine, sucralose, neotame, aspartame, alitame, acesulfame or natural sugars with a high sweetening power such as stevia, can be used in combination with conventional sugars and sugar types or also alone.

With regard to further additives, such as citric acid, food syrups, fragrances, dyes, waxes, fillers, materials with pre-biotic activity such as inulin or RS, coating agents, additives, etc., reference is made to the adequately known state of the art. Likewise, reference is made to the state of the art with respect to the geometric shapes of the inventive candy.

Method:

In principle, all components, required for a particular candy, can be prepared together, for example, by extrusion or boiling methods. In order to make a preparation at low water contents possible, it may be advantageous to prepare the NS separately, especially to dissolve it and then mix it with the other components. Furthermore, the possibility also exists of preparing the starch component first, the VS and NS being prepared together, or to prepare the NS separately and then mix it with the VS, after which the further candy components are mixed in. In addition, the VS and/or NS starch components can also be prepared as a pre-product and used in this form. Furthermore, common methods may be employed for producing the candy, for example, by means of casting techniques (mogul technique) or extrusion molding. In addition, the candy may also be shaped by means of advantageously priced injection molding techniques. The water content of the candy produced ranges from 3 to 40%, preferably from 4 to 30%, especially from 5 to 20% and particularly from 5 to 15% before a possible conditioning.

The patent applications WO 03/035026 A2 and WO 03/035044 A2 are referred to for a detailed description of the preparation of VS and NS and the German patent application of Mar. 28, 2003 with the file number 103 14 418.8 is referred to for detailed information concerning the pre-product.

### EXAMPLES

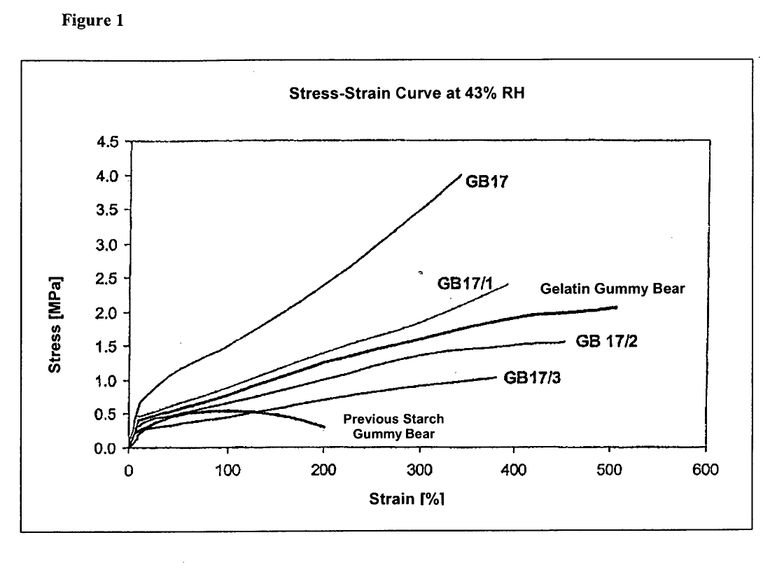

For the examples, rubbery elastic candy was prepared, on the one hand, with a Brabender kneader and, on the other, by means of a microwave oven, comparable results being obtained. In both cases, the NS was prepared separately and then mixed with the remaining components. For this purpose, the mixing process was carried out with water contents ranging from 10 to 20% and at temperatures ranging from 80° to 130° C. The formulation s of the examples are listed in Table 1. Characteristic properties of the formulations are shown in FIGS. 1 to 11 and are explained in detail in the following. The examples are not intended to be limiting.

1. In FIG. 1, the stress-strain curves, obtained in tensile tests from samples, which were in equilibrium with air having a relative humidity of 43%, are given for different formulations of rubber-elastic candy based on starch (GSB) based on an NS-containing network (the linkage points of which are formed by homocrystallites as well as by heterocrystallites), as well as for gelatin gummy bears (GGB) and previous starch (gummy) bears (SB). The corresponding GSB formulations are listed in Table 1. It is shown that the stress-strain curve of the basic formulation GB17 can be adjusted over a wide range by varying the plasticizer content and adapted qualitatively as well as quantitatively to the stress-strain curve of GGB, whereas SB shows a different behavior qualitatively as well as quantitatively.

The stress-strain curves of GSB and GGB are typical for rubber-elastic behavior (the rubber-like texture), whereas the stress-strain curve of GB reflect aplastic flow (viscous texture).

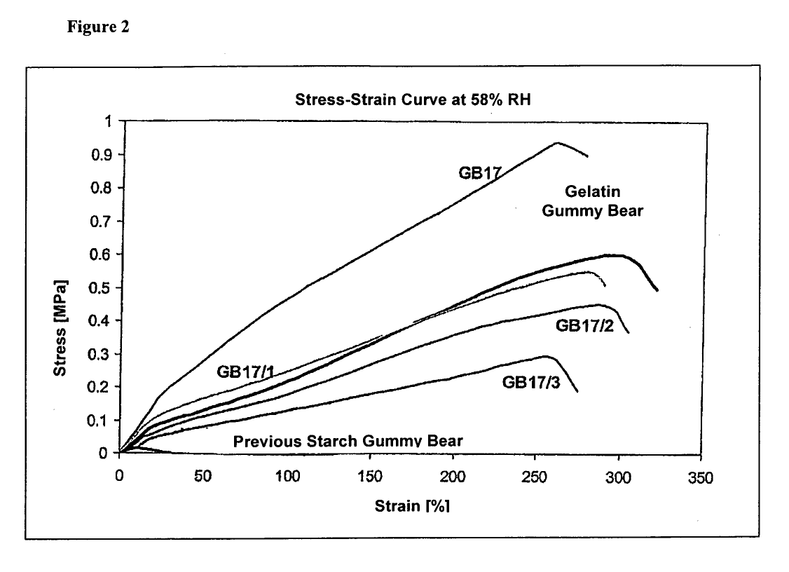

2. In FIG. 2, the stress-strain curves of the same samples, which are in equilibrium with a relative humidity of 58%, are shown. Qualitatively, the stress-strain curves of GSB and GGB are comparable with the results at a relative humidity of 43%. However, because of the higher water content, the strengths are lower and the strengths of SB are hardly measurable anymore in tensile tests at this humidity (pronounced flow at the slightest stress). In view of the results of FIG. 2, it is not surprising that GGB and SB have a completely different texture and, with that, a completely different behavior while being consumed (biting behavior) (the water contents of GGB and SP, when sold, correspond approximately to the equilibrium moisture content at a relative humidity of 58%). Especially the rubber-like behavior, which is so popular in the case of GGB, cannot be reproduced even approximately by SB. On the other hand, GSB makes possible a texture, which is practically identical with that of GB (compare GGB 17/1).

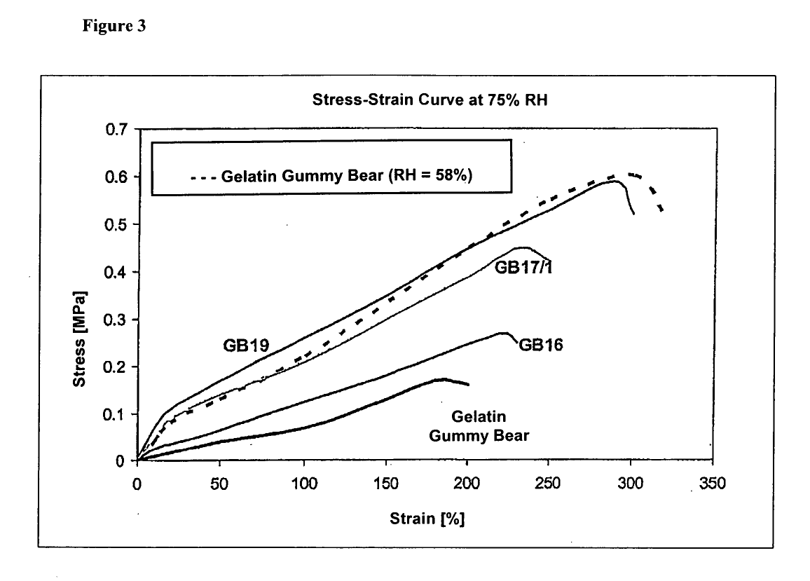

3. The strength and elongation at break of GGB are reduced clearly if the relative humidity is increased further to 75% (FIG. 3), whereas SB can no longer be measured in a tensile test under these conditions. At a relative humidity of 75%, the viscous character of the SB texture is expressed even more clearly, since the samples begin to flow already under their own weight. The GGB are much softer at a relative humidity of 75% than at a relative humidity at a relative humidity of 58%. However, they still have a rubber-like texture. The texture of GSB, on the other hand, is different only slightly at a relative humidity of 75% from the behavior at 58% and the course of the stress-strain curve of GB17/1 at a relative humidity of 75%, with the exception of a somewhat lower elongation at break, is even almost identical with the stress-strain curve of GGB at a relative humidity of 58%. The stabilization of the texture of GSB at high relative humidities or water contents is a consequence of the inherent network. Accordingly, not only is the texture of GSB comparable with that of GGB, but the properties of GSB are less sensitive to changes in relative humidity or water content than do the properties of GGB.

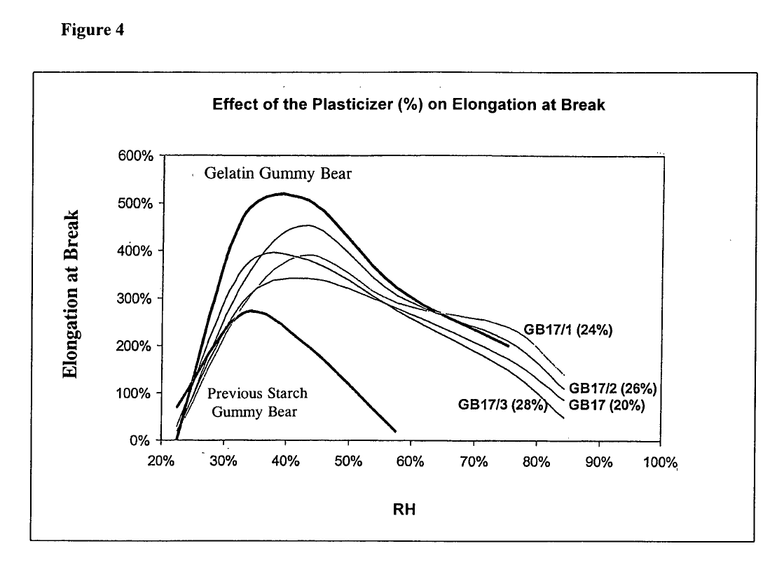

4. The course of the elongations at break of GGB, GSB and SB are given as a function of the relative humidity at equilibrium in FIG. 4. In each case, the curves show a maximum at a relative humidity ranging from 35% to 45%. In this range, GB attains the highest elongations and SB the lowest, whereas the elongations of SGB are in between and, in particular, closer to the elongations of GGB. At a relative humidity of 60%, this humidity being in equilibrium with the water content, at which the GGB and SB are sold, the elongations at break of GGB and GSB are almost identical, whereas SB has only a minimum elongation here. Aside from the maximum elongations, which are very high in comparison to those of SB, a wide range of relative humidities from 25% to 85%, in which elongations of more than 100% obtained, is characteristic of GSB. On the other hand, for SB, such elongations are obtained only for relative humidities between 25% and 50%. With respect to this property, there is also a clear difference between GSB and SB, GSB having not only the advantage over SB of a rubber-elastic texture, but also, with regard to the relative humidity, the advantage of a broader area of application even in comparison with gelatin.

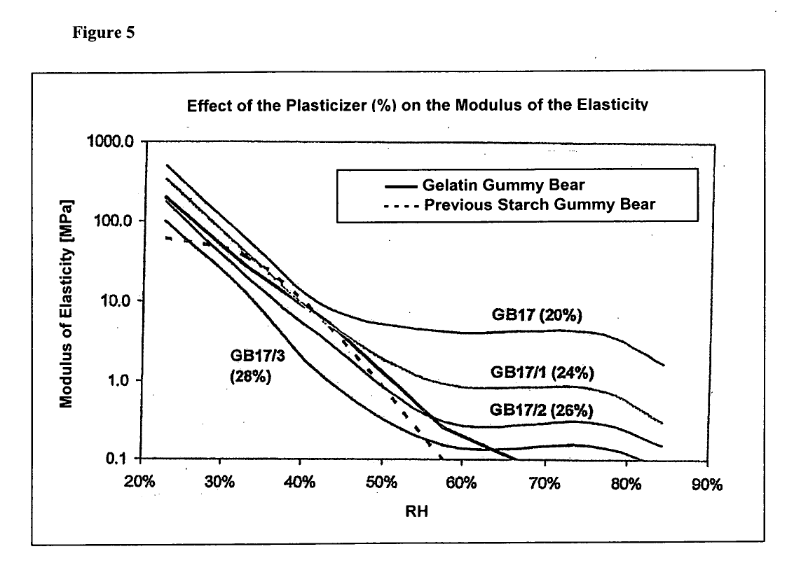

5. The course of the modulus of elasticity of GGB, GSB and SB is shown in semilogarithmic form as a function of the relative humidity in FIG. 5. The logarithm of the modulus of elasticity of GGB decreases almost linearly with relative humidity. On the other hand, for GSB, it reaches a plateau above about 50% relative humidity. This corresponds to an approximately constant texture up to high relative humidities and is due to the presence of a network. The level of the plateau for a selected VS can be adjusted within a wide range by varying the plasticizer content. In addition, by increasing the plasticizer content, the linear range of the modulus of elasticity is shifted to lower relative humidities. Sugars and sugar types, customary in candy, have approximately the same effect as plasticizers on the course of the modulus of elasticity; however, the effect is less. It becomes clear from this that, for a selected VS, a wide range of rubber elastic textures from soft to hard can be obtained by means of the plasticizer content and, less pronouncedly, by means of the sugar and sugar type content, so that the range of uses of GSB goes beyond the replacement of gelatin in gummy bears. Further candy textures can be adjusted, which characteristically have a plateau of the modulus of elasticity at higher relative humidities or higher water contents. For example, the GB17 formulation shows a hard rubber elastic texture, which is comparable with gummy cough drops.

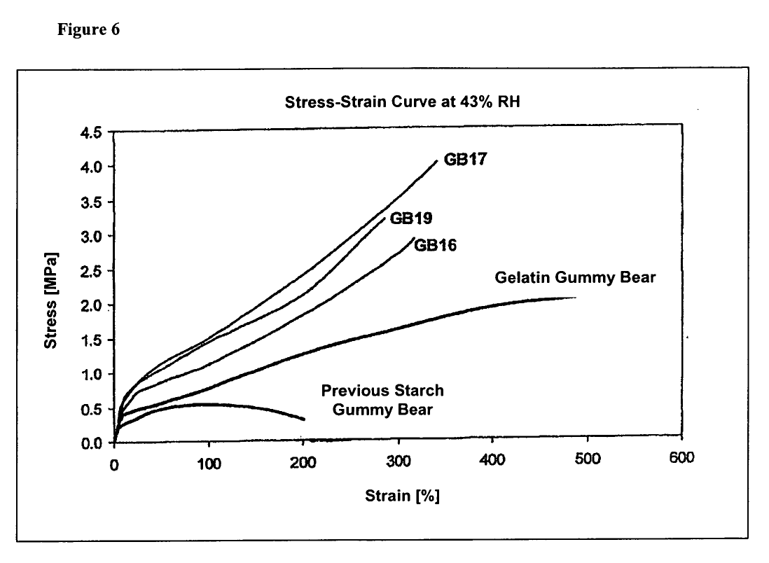

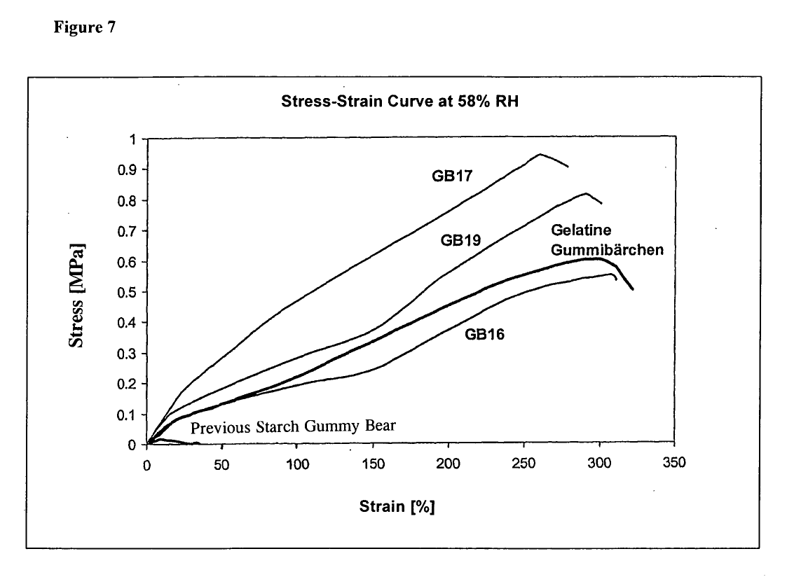

6. From FIGS. 6 and 7 and formulations GB16 and GB19 (neither of which contains NS, it becomes clear that networks, the linkage points of which are formed by homocrystallites, may also have a texture comparable to that of GGB. However, for these formulations, the stabilization of the texture at high relative humidities is less pronounced and the modulus of elasticity plateau is at a lower level.

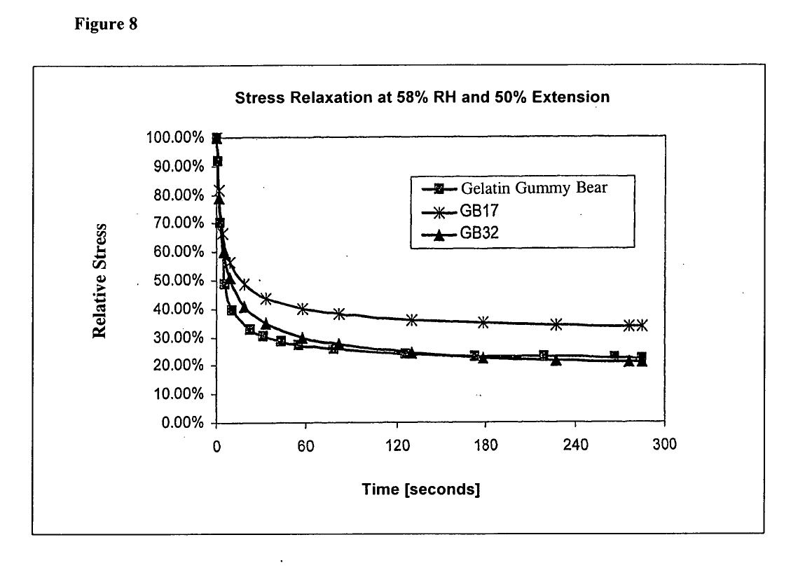

7. Stress-strain relaxation measurements were carried out to compare the rubber-elastic behavior of inventive candy with that of gelatin. For this purpose, samples, which had been equilibrated at a relative humidity of 58%, were stretched rapidly by 50%, after which the decreasing stress was measured as a function of time. The results for gelatin, as well as for a hard rubber-elastic formulation GB17 and for a soft rubber-elastic texture GB32 are shown in FIG. 8. Corresponding measurements could not be carried out with SB, because the latter has an elongations at break of almost 0 at a relative humidity of 58%. A relaxation curve, which, after an initial rapid decrease, approaches a plateau asymptotically, is characteristic of rubber-elastic behavior. The height of the plateau may be interpreted as the degree of rubber elasticity. In this sense, GB32 and GGB have almost identical relaxation behavior and GB17 shows even a high degree of rubber elasticity.

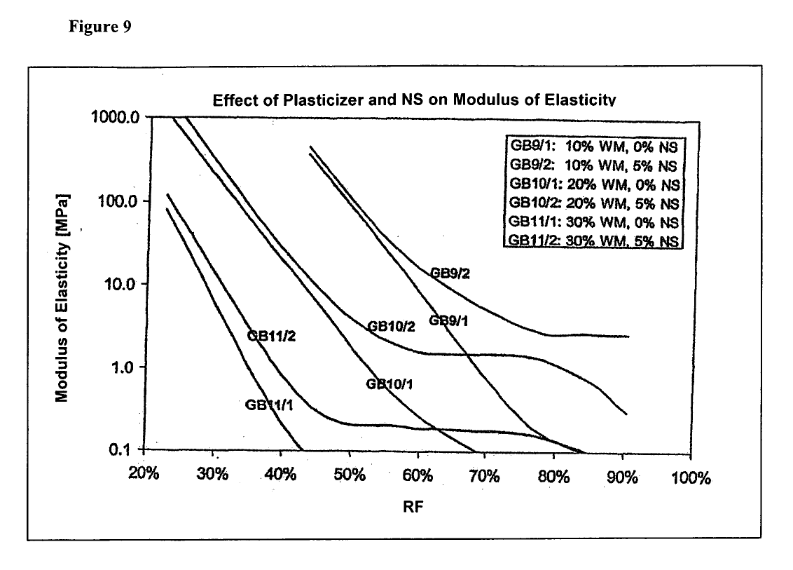

8. The effect of plasticizer and NS on the modulus of elasticity is shown in semilogarithmic form in FIG. 9 for formulations based on acetylated distarch adipate of waxy corn. The formulations containing NS have a modulus of elasticity plateau, which, in the case of GB11/2 extends over a wide range of relative humidities of about 35%. On the other hand, formulations without NS show only a flattening of the modulus of elasticity in the plateau regions. Here also, the stabilizing effect of the network is expressed once again and, in these cases, includes heterocrystallites at least partially. It becomes clear that, by means of a variation of the plasticizer content, on the one hand, a translation along the relative humidity axis is initiated and, on the other, for the formulations containing a portion of NS, a translation along the modulus of elasticity axis is also associated, the level of the modulus of elasticity varying by a factor of up to 20. Accordingly, the modulus of elasticity curve can be placed within a wide range of the modulus of elasticity/relative humidity diagram by selecting the plasticizer content, as a result of which one possibility is provided for adjusting the rubber-elastic textures desired from hard (GB11/2) to soft (GB9/2). However, the translation along the RF axis is not independent of the translation along the modulus of elasticity axis for formulations containing NS. The possibility of independent translation along the two axes of the modulus of elasticity and the relative humidity is desirable for producing an even greater spectrum of rubber-elastic textures.

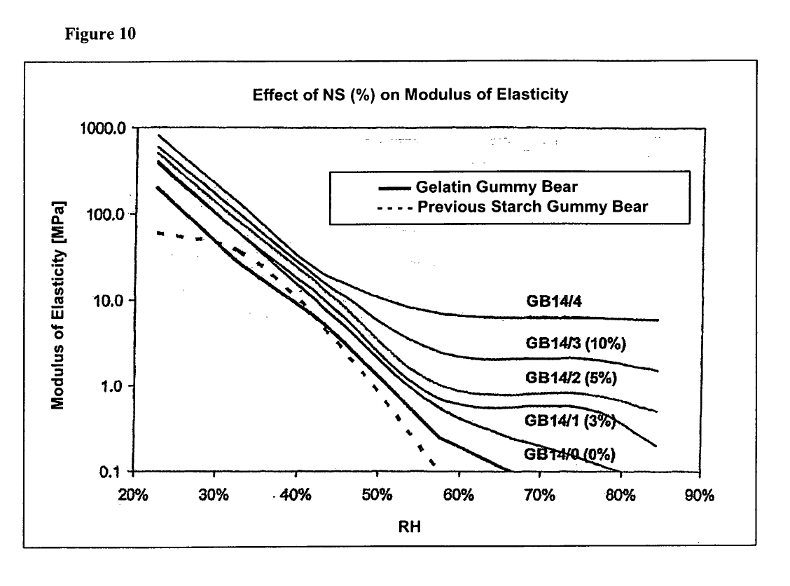

9. This becomes possible due to the nature and content of the NS, as shown in FIG. 10. Increasing the NS content is expressed in a shift of the modulus of elasticity plateau to a higher modulus of elasticity, an increase in the NS content from 3% to 15% raising the modulus of elasticity plateau by a factor of about 10, whereas the translation along the relative humidity axis is comparatively slight. Accordingly, the level of the modulus of elasticity plateau and the position of this plateau with respect to the relative humidity can be adjusted over a wide range to a desired value with the parameters of plasticizer content and NS content. At the same time, the range where the logarithms of the moduli of elasticity decreases with RH, can also be fixed along both content parameter axes. Even if, furthermore, the selected VS is varied, there still is a larger tolerance. However, these possibilities for variation relate not only to the course of the modulus of elasticity as an important characteristic quantity of the texture, the elongation capability is also adjustable, a high NS content generally reducing the elongation capability and a high degree of substitution of the VS increasing the elongation capability. Furthermore, the fracturing behavior with the available parameters from viscous to brittle and the tackiness from strongly tacky at low network densities to not tacky at high network densities as well as the transparency from opaque, in the case of the large homocrystallites or heterocrystallites, to transparent, in the case of small heterocrystallites, can also be adjusted. The size of the crystallites can be controlled in formulations not containing any NS by the degree of substitution of the VS and, in formulations containing, furthermore, NS, by the degree of polymerization of the NS and the crystallization kinetics.

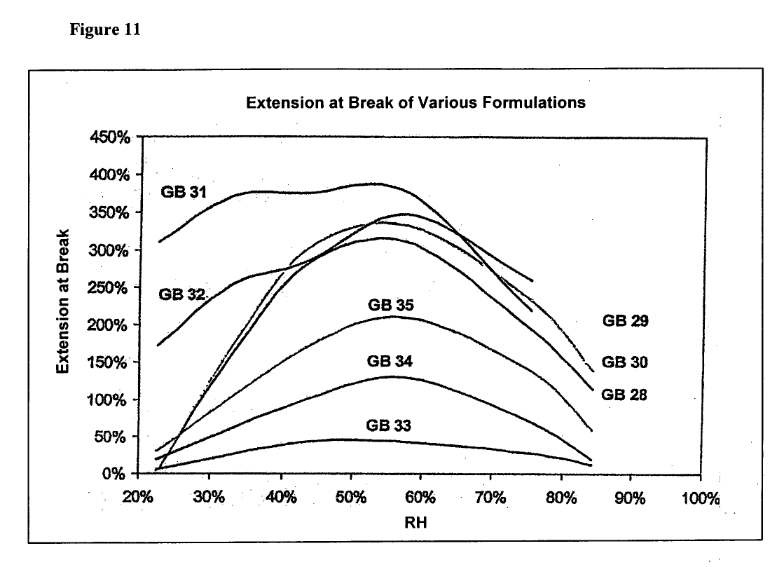

10. The elongations at break of various formulations are given as a function of the relative humidity in FIG. 11. The effect of an increased proportion of sugar and high maltose syrup is shown by a comparison of GB28 and GB29, higher elongations being obtained. The comparison of GB28, GB30 and GB32 shows the effect of a reduction in the NS content, a reduction in the NS content permitting somewhat higher elongations. The difference between GB28 and GB30, however, is a relatively slight, whereas a 0% proportion in the case of GB32 clearly increases the elongation at break, especially at a low relative humidity. Compared to GB28, GB31 has a higher plasticizer content, as a result of which very high elongations can be achieved even at a low relative humidity.

A thin-boiling, acid hydrolyzed and esterified starch was used in the GB33 formulation in combination with NS. The elongations are clearly reduced thereby and the texture is short and suitable for jelly. For the GB34 formulation, the same starch was combined up to 80% with a higher molecular weight, substituted starch, whereas, for formulation GB35, a thin-boiling, acetylated/oxidized starch was combined up to 60% with a higher molecular weight, substituted starch. In both cases, 10% NS was used and, accordingly, heterocrystallites were obtained at least partially. The measured elongations at break show that elongation at break curves were obtained by such combinations, which can be adjusted between the elongations at break curves of rubber-elastic candy, such as in the case of GB28 and GB30, and jelly candy such as in the case of GB33. The corresponding textures lie between the textures of gummy candies and jelly and are therefore novel.

TABLE 1
Formulations (the percentages given are related in each case to the dry
weight and the proportion of VS; WM: plasticizer, HNS: high maltose syrup,
NS1: DPn = approximately 20, NS2: DPn = approximately 100).

| | | | NS | WM | HMS | Sugar |
|---|---|---|---|---|---|---|
| Nr. | VS | NS | [%] | [%] | [%] | [%] |
| GB9/1 | Acetylated starch Diadipate (Waxy Corn) | NS2 | 0 | 10 | 20 | 30 |
| GB9/2 | Acetylated starch Diadipate (Waxy Corn) | NS2 | 5 | 10 | 20 | 30 |
| GB10/1 | Acetylated starch Diadipate (Waxy Corn) | NS2 | 0 | 20 | 20 | 30 |
| GB10/2 | Acetylated starch Diadipate (Waxy Corn) | NS2 | 5 | 20 | 20 | 30 |
| GB11/1 | Acetylated starch Diadipate (Waxy Corn) | NS2 | 0 | 30 | 20 | 30 |
| GB11/2 | Acetylated starch Diadipate (Waxy Corn) | NS2 | 5 | 30 | 20 | 30 |
| GB14/0 | Acetylated starch Diadipate (Tapioca) | NS1 | 0 | 20 | 20 | 30 |
| GB14/1 | Acetylated starch Diadipate (Tapioca) | NS1 | 3 | 20 | 20 | 30 |
| GB14/2 | Acetylated starch Diadipate (Tapioca) | NS1 | 5 | 20 | 20 | 30 |
| GB14/3 | Acetylated starch Diadipate (Tapioca) | NS1 | 10 | 20 | 20 | 30 |
| GB14/4 | Acetylated starch Diadipate (Tapioca) | NS1 | 15 | 20 | 20 | 30 |
| GB16 | Hydroxypropylated Starch Diphosphate (Tapioca) | None | — | 20 | 25 | 40 |
| GB17 | Hydroxypropylated Starch Diphosphate (Tapioca) | NS1 | 5 | 20 | 30 | 45 |
| GB17/1 | Hydroxypropylated Starch Diphosphate (Tapioca) | NS1 | 5 | 24 | 30 | 45 |
| GB17/2 | Hydroxypropylated Starch Diphosphate (Tapioca) | NS1 | 5 | 26 | 30 | 45 |
| GB17/3 | Hydroxypropylated Starch Diphosphate (Tapioca) | NS1 | 5 | 28 | 30 | 45 |
| GB19 | Hydroxypropylated Starch (Potato) | None | — | 20 | 25 | 40 |
| GB28 | Hydroxypropylated Starch Diphosphate (Tapioca) | NS1 | 10 | 20 | 31 | 47 |
| GB29 | Hydroxypropylated Starch Diphosphate (Tapioca) | NS1 | 10 | 20 | 37 | 56 |
| GB30 | Hydroxypropylated Starch Diphosphate (Tapioca) | NS2 | 5 | 20 | 31 | 47 |
| GB31 | Hydroxypropylated Starch Diphosphate (Tapioca) | NS1 | 10 | 30 | 31 | 47 |
| GB32 | Hydroxypropylaled Starch Diphosphate (Tapioca) | None | 0 | 20 | 30 | 45 |
| GB33 | Acid Hydrolyzed Esterified Potato Starch | NS1 | 10 | 20 | 30 | 45 |
| GB34 | Hydroxypropylated Starch Diphosphate (Tapioca) + Acid | NS1 | 10 | 20 | 30 | 45 |
| | Hydrolyzed Esterified Potato Starch (80%) | | | | | |
| GB35 | Hydroxypropylated Starch Diphosphate (Tapioca) + | NS1 | 10 | 20 | 30 | 45 |
| | Acetylated/Oxidized Potato Starch (60%) | | | | | |

1. Candy based on a starch matrix, wherein the candy has a rubber-elastic texture.

2. The candy based on a starch matrix of claim 1, wherein the modulus of elasticity of the candy has a plateau, which is a function of the relative humidity, it being possible, in particular, to position this quasi-plateau by the formulation parameters along the axis of the relative humidity and along the axis of the modulus of elasticity.

3. The candy based on a starch matrix of claims 1 or 2, wherein the candy, in equilibrium with a relative humidity of 5 5% to 70%, has a relaxation tension of more than 10%, preferably more than 15%, especially of more than 20%, particularly of more than 25% and more particularly of more than 30% at an elongations of 50%.

4. The candy based on a starch matrix of claims 1 or 2, wherein the candy has an elongation at break of more than 50%, preferably of more than 100% and most preferably of more than 150% in a relative humidity interval of more than 30%, preferably more than 40%, particularly of more than 50 and most particularly of more than 60%.

5. The candy based on a starch matrix of claims 1 or 2, wherein:
a) the starch matrix has a network, which is formed by homocrystallites and/or heterocrystallites and
b) has at least one starch with a DPn of more than 150, preferably more than 300, more preferably of more than 500, particularly of more than 750 and most particularly of more than 1000 and/or
c) at least one network-capable starch with a DPn of less than 300, preferably of less than 150, especially of less than 100, particularly of less than 75 and most particularly of less than 50.

6. The candy based on a starch matrix of claims 1 or 2, wherein:
a) the candy contains 0-50%, preferably 1-40%, particularly 3-35% and most particularly 3-30% of plasticizer and
b) the candy contains 1-90%, preferably 5-85%, particularly 10-80% and most particularly 20-75% of sugar and sugar types and
c) the candy optionally contains a proportion of 1-50%, preferably 1.5-30%, particularly 2-20% and most particularly 3-15% of network-capable starch,
the proportion in percent in a), b) and c) being based on the dry weights and on the proportion of starch present.

7. The candy based on a starch matrix of claims 1 or 2, wherein:
a) it is possible to adjust the candy with respect to its optical properties from opaque to transparent and
b) it is possible to adjust the surface of the candy without a coating agent from tacky to not tacky and
c) it is possible to adjust the candy with respect to its breakage behavior from a viscous to a brittle, that is, glassy break.

8. The candy based on a starch matrix of claims 1 or 2, wherein the candy has at least one retrogradation-inhibiting material, especially glycogen or a dextran with a degree of branching of more than 0.05, preferably of more than 0.10, particularly of more than 0.15 and most particularly of more than 0.3.

9. The candy based on a starch matrix of claims 1 or 2, wherein the candy is produced by means of a pre-product containing at least VS and/or NS, the preparation of the pre-product suppressing the formation of a network and the amorphous state being frozen in.

10. Method for the preparation of candy of claims 1 or 2, wherein the preparation of the candy is carried out by a method common in candy manufacture such as, for example, by means of boiling and casting methods (such as the mogul technique), especially by means of a jet-cooking method or a vacuum cooking method, by means of mold extrusion, as well as by means of injection molding techniques, conditioning being carried out at the conclusion of the molding by the respective method.

11. Use of candy based on a starch matrix of claims 1 or 2, wherein the candy is in the area of gummy candy,jelly sugar goods, cough drops, hard and soft rubber-elastic candy and the like, especially as a replacement for candy based on gelatin, pectin, gum Arabic or agar and the like, especially as gummy bears, gummy candy, jelly, cough drops, hard and soft rubber-elastic candy and the like.
